(19) United States
(12) Patent Application Publication
(10) Pub. No.: US 2015/0218745 A1
(43) Pub. Date: Aug. 6, 2015

(54) ELECTRONIC DEVICE, COMPUTER PROGRAM PRODUCT, AND METHOD FOR CONTROLLING DISPLAY

(71) Applicant: Kabushiki Kaisha Toshiba, Tokyo (JP)

(72) Inventors: Satoshi Odakura, Kodaira (JP); Noriyuki Hirayama, Fuchu (JP)

(21) Appl. No.: 14/526,155

(22) Filed: Oct. 28, 2014

(30) Foreign Application Priority Data
Jan. 31, 2014 (JP) 2014-017704

(51) Int. Cl. D06F 39/00; G08B 5/36

(52) U.S. Cl. CPC D06F 39/005; G08B 5/36

(57) ABSTRACT

According to one embodiment, an electronic device includes a receiver and a display controller. The receiver is configured to receive information indicating an operation course and information indicating a process currently performed by a washer dryer from the washer dryer. The washer dryer is configured to operate in accordance with the operation course including one or more processes out of at least four processes. The display controller is configured to display a screen including at least four display areas corresponding to the at least four processes on a display. The screen is configured to display one or more processes included in the operation course in the display areas in such a manner that the process currently performed by the washer dryer, a process to be performed hereafter by the washer dryer, and a process previously performed by the washer dryer are discriminable from each other.

### CROSS-REFERENCE TO RELATED APPLICATIONS

This application is based upon and claims the benefit of priority from Japanese Patent Application No. 2014-017704, filed Jan. 31, 2014, the entire contents of which are incorporated herein by reference.

### FIELD

Embodiments described herein relate generally to an electronic device, a computer program product, and a method for controlling display.

### BACKGROUND

Conventionally, there has been known a technique that confirms remotely the progress of each process included in an operation course set in a washer dryer with the use of a display terminal. In such a technique, the display terminal displays a process currently performed by the washer dryer and a process to be performed hereafter by the washer dryer on a display screen and, on the other hand, does not display a process previously performed by the washer dryer on the display screen.

The above conventional technique has been incapable of identifying whether a process that is not displayed on the display screen is a process that is performed previously by the washer dryer or a process that is not originally included in an operation course set to the washer dryer just by looking at the display screen.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view illustrating one example of an appearance of each of a display terminal and a washer dryer according to an embodiment;

FIG. 2 is an exemplary block diagram illustrating one example of an internal configuration of the display terminal in the embodiment;

FIG. 3 is an exemplary block diagram illustrating one example of a functional configuration of an information display program executed by a controller of the display terminal in the embodiment;

FIG. 4 is an exemplary view illustrating one example of an operation status display screen in the embodiment;

FIG. 5 is an exemplary illustrative view illustrating one example, which is different from the example in FIG. 4, of the operation status display screen in the embodiment;

FIG. 6 is an exemplary illustrative view for explaining one example of the transition of the operation status display screen illustrated in FIG. 5, in the embodiment;

FIG. 7 is an exemplary illustrative view for explaining one example of the transition of the operation status display screen illustrated in FIG. 6, in the embodiment;

FIG. 8 is an exemplary illustrative view for explaining one example of the transition of the operation status display screen illustrated in FIG. 7, in the embodiment;

FIG. 9 is an exemplary view illustrating a state that an instantaneous value and an integrated value of power consumption of the washer dryer are displayed on the operation status display screen in the embodiment; and

FIG. 10 is an exemplary illustrative flowchart illustrating the processing executed by the controller of the display terminal in the embodiment.

### DETAILED DESCRIPTION

In general, according to one embodiment, an electronic device comprises a receiver and a display controller. The receiver is configured to receive information configured to indicate an operation course and information configured to indicate a process currently performed by a washer dryer from the washer dryer. The washer dryer is configured to operate in accordance with the operation course comprising one or more processes out of at least four processes comprising washing, rinsing, dewatering, and drying. The display controller is configured to display a screen comprising at least four display areas corresponding to the at least four processes on a display. The screen is configured to display one or more processes comprised in the operation course in the display areas in such a manner that the process currently performed by the washer dryer, a process to be performed hereafter by the washer dryer, and a process previously performed by the washer dryer are discriminable from each other.

Hereinafter, embodiments are explained in conjunction with drawings.

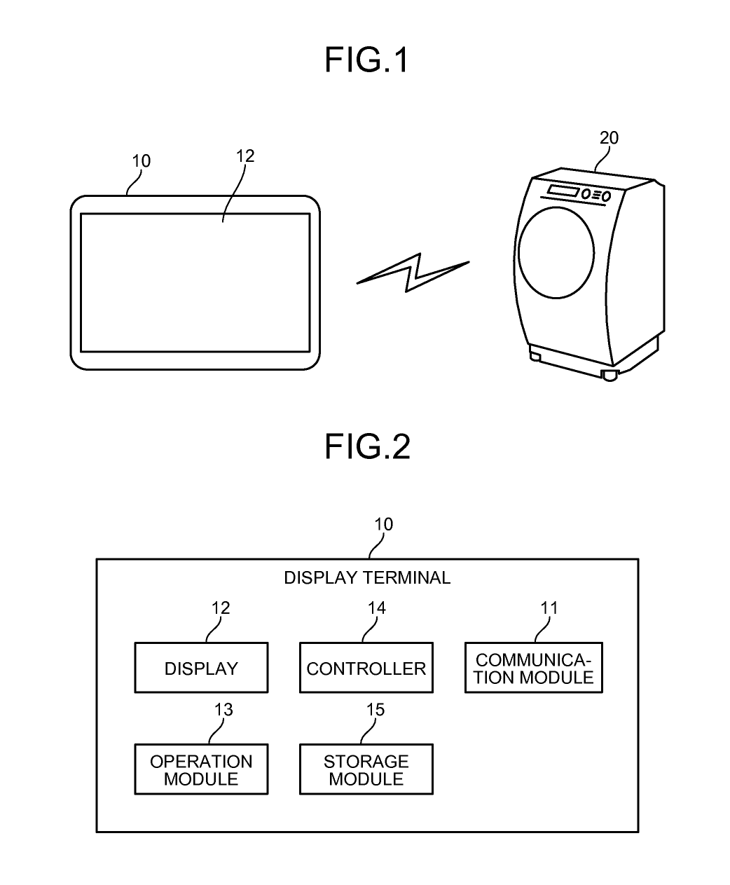

First of all, with reference to FIG. 1 to FIG. 3, one example of a configuration of a display terminal 10 according to the embodiment is explained. Here, the display terminal 10 is one example of an “electronic device.” In the embodiment, as one example, the display terminal 10 is explained, achieved as a portable information processing device (a smart phone, a tablet, or the like) provided with a display.

As illustrated in FIG. 1, the display terminal 10 and a washer dryer 20 are configured to be capable of performing radio communications mutually. Here, the washer dryer 20 is installed in a home, and configured to operate in accordance with an operation course set by a user. The operation course includes one or more processes out of at least four processes including washing, rinsing, dewatering, and drying. As a method for communicating between such devices used at home, ECHONET Lite (ECHONET is a registered trademark) is listed, for example.

Here, although FIG. 1 illustrates the example that the display terminal 10 and the washer dryer 20 perform radio communications mutually, the embodiment is not limited to this example. In the embodiment, the display terminal 10 and the washer dryer 20 may be configured to perform cable communications mutually. Furthermore, in the embodiment, as a method for communicating between the display terminal 10 and the washer dryer 20, a method other than ECHONET Lite (ECHONET is a registered trademark) may be used. In addition, in the embodiment, the operation course may include processes other than the above-mentioned four processes.

Next, with reference to FIG. 2, an internal configuration of the display terminal 10 is specifically explained. As illustrated in FIG. 2, the display terminal 10 comprises a communication module 11, a display 12, an operation module 13, a controller 14, and a storage module 15.

The communication module 11 is an interface used for communicating with the washer dryer 20. The display 12 is configured to be capable of displaying a still picture, a video, or the like. The operation module 13 is a module for operating the display terminal 10, and constituted of a touch panel using the display 12, for example.

The controller 14 comprises a central processing unit (CPU) or the like, and is configured to perform various kinds of arithmetic processing for controlling each module in the display terminal 10 based on various kinds of computer programs installed in the display terminal 10. The storage module 15 comprises a read only memory (ROM), a random access memory (RAM), or the like, and is configured to store therein various kinds of computer programs executed by the controller 14, various kinds of data used for execution of the various kinds of computer programs, or the like.

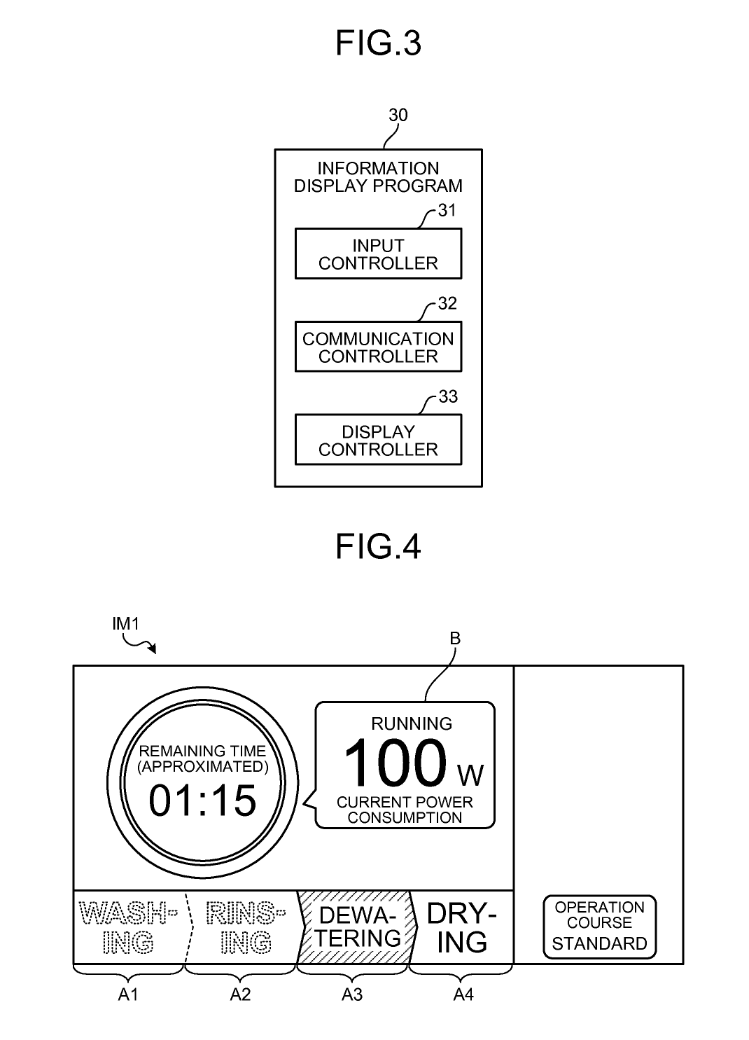

For example, the controller 14 in the embodiment is configured to execute an information display program 30 as illustrated in FIG. 3. The information display program 30 comprises an input controller 31, a communication controller 32, and a display controller 33 as functional components. Here, the communication controller 32 is one example of a “receiver.”

The input controller 31 has a function to accept the operation input of a user from the operation module 13. The communication controller 32 has a function to control communications of various kinds of data via the communication module 11. The display controller 33 has a function to control the display of various kinds of information on the display 12.

The communication controller 32 is configured to receive (acquire) information that indicates an operation course currently set to the washer dryer 20 and information that indicates an process currently performed by the washer dryer 20. Furthermore, the communication controller 32 is configured to acquire information that indicates an operation course or a process as well as information that indicates power consumption of the washer dryer 20 (specifically described later), information that indicates a remaining time until the operation course is completed, information that indicates whether the washer dryer 20 is in operation or under suspension, or the like from the washer dryer 20.

The display controller 33 is configured to display, when the communication controller 32 acquires various kinds of information mentioned above, operation status display screens IM1 to IM6 as illustrated in FIG. 4 to FIG. 9 on the display 12 based on the various kinds of information. Hereinafter, for the sake of simplicity, the operation status display screens IM1 to IM6 are merely described as screens IM1 to IM6, respectively. The display controller 33 is configured to display the screens IM1 to IM6 on the display 12 when an operation course is set to the washer dryer 20 and an operation start instruction is made with respect to the washer dryer 20 by a user.

As illustrated in FIG. 4 to FIG. 9, each of the screens IM1 to IM6 comprises four display areas A1 to A4 corresponding to four processes of washing, rinsing, dewatering, and drying, respectively, that are performed by the washer dryer 20. The four display areas A1 to A4 are configured to be capable of respectively displaying thereon character strings that indicate the names of respective four processes. Furthermore, each of the screens IM1 to IM6 is also configured to be capable of displaying a balloon B for displaying power consumption of the washer dryer 20, a remaining time until an operation in accordance with an operation course is completed, or the like.

Here, each of the screens IM1 to IM6 is configured to display each of one or more processes included in an operation course received by the communication controller 32 on a corresponding area out of the four display areas A1 to A4 in such a manner that a process currently performed by the washer dryer 20, a process to be performed hereafter by the washer dryer 20, and a process previously performed by the washer dryer 20 can be discriminated from each other.

To be more specific, the display controller 33 is configured to display, in order to notify a user of the process currently performed by the washer dryer 20 in a discriminable manner from the other processes, an area corresponding to the process currently performed by the washer dryer 20 out of the four display areas A1 to A4 in such a manner that the area corresponding to the process currently performed by the washer dryer 20 provides more bright display than the other areas. Furthermore, the display controller 33 is configured to display, in order to notify a user of the process previously performed by the washer dryer 20 in a discriminable manner from the other processes, the character string that indicates the name of the process performed previously by the washer dryer 20 in the display area Al to A4 in a state that the character string that indicates the name of the process performed previously by the washer dryer 20 is displayed darkly (in a grayout manner) relative to a character string that indicates the name of the other process.

For example, the screen IM1 illustrated in FIG. 4 indicates that, in the case where an operation course (standard course) including all of the four processes of washing, rinsing, dewatering, and drying is set to the washer dryer 20, the washing and the rinsing are previously completed, the dewatering is currently performed, and the drying is to be performed hereafter.

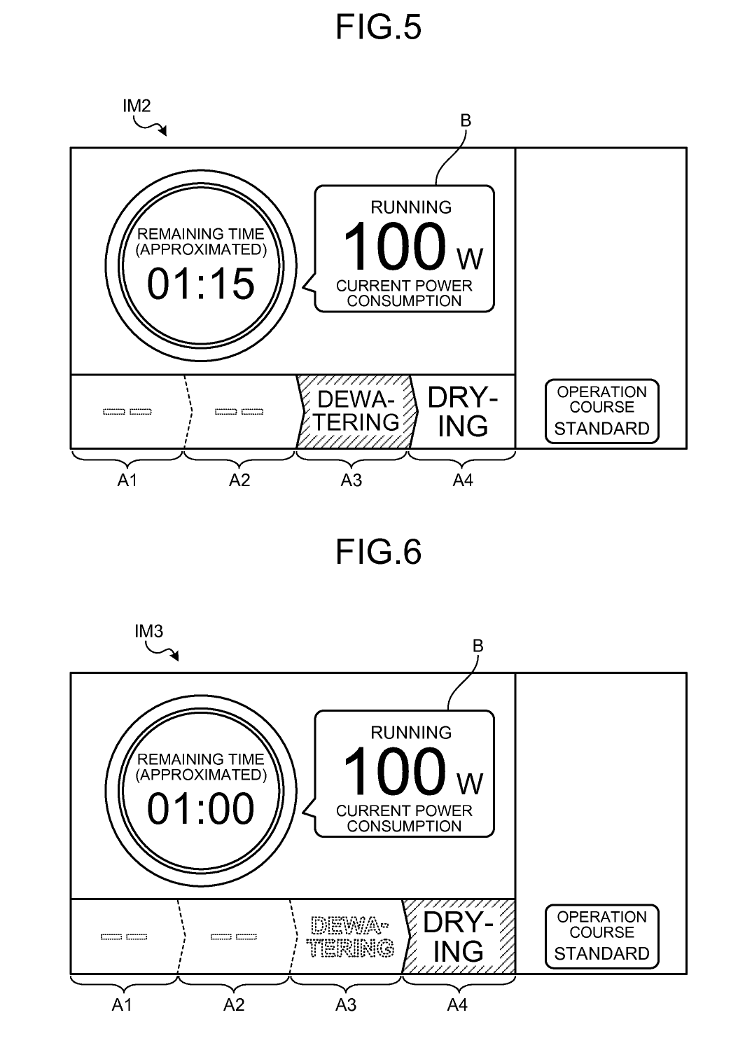

Furthermore, the screen IM2 illustrated in FIG. 5 indicates that, in the case where an operation course that performs only the dewatering and the drying in the standard courses is set to the washer dryer 20, the dewatering is currently performed and the drying is to be performed hereafter.

Here, as illustrated in FIG. 5, the display controller 33 is configured to display processes (washing and rinsing) that are not included in an operation course on corresponding areas out of the display areas A1 to A4 in a manner capable of identifying that the processes are not included in the operation course. To be more specific, the display controller 33 is configured to display hyphens “--” in a grayout manner in the area corresponding to the process that is not included in the operation course (the display areas A1 and A2 in FIG. 5) out of the four display areas A1 to A4 so as not to display the name of the process that is not included in the operation course. Here, in the embodiment, as long as it can be identified that a process is not included in an operation course, the name of the process that is not included in the operation course may be displayed. Furthermore, in the embodiment, the display controller 33 may be configured to hide completely a process that is not included in an operation course without displaying even hyphens in a grayout manner.

In addition, the display controller 33 is configured to display fixedly the four display areas A1 to A4 in each of the screens IM1 to IM6 in a state that the four processes are arranged on the four display areas in the order that the four processes are performed. That is, in each of the screens IM1 to IM6, the four display areas A1 to A4 are displayed next to each other in order of the display area A1 corresponding to washing, the display area A2 corresponding to rinsing, the display area A3 corresponding to dewatering, and the display area A4 corresponding to drying.

Furthermore, the communication controller 32 is configured to receive (acquire) periodically the above-mentioned various kinds of information including information that indicates an operation course and the current process at certain intervals (at 30-second intervals, for example). In addition, the display controller 33 is configured to change over, when the information acquired by the communication controller 32 is updated, the displays of the screens IM1 to IM6 depending on the contents of the updated information.

For example, to consider a case where the above-mentioned screen IM2 illustrated in FIG. 5 is displayed, when it is determined that dewatering is completed based on the information acquired by the communication controller 32, the display controller 33 is configured to switch the screen IM2 to the screen IM3 illustrated in FIG. 6. The screen IM3 illustrated in FIG. 6 indicates that, when the above-mentioned operation course same as the case in FIG. 5 is set to the washer dryer 20, the dewatering is previously completed and the drying is currently performed.

Here, in the embodiment, the washer dryer 20 configured to automatically transmit, when the current process advances to the subsequent process, information that indicates the subsequent process to the display terminal 10 may be used. In this case, the display controller 33 is configured to change over, when receiving the information automatically transmitted from the washer dryer 20, the screens IM1 to IM6 based on the information.

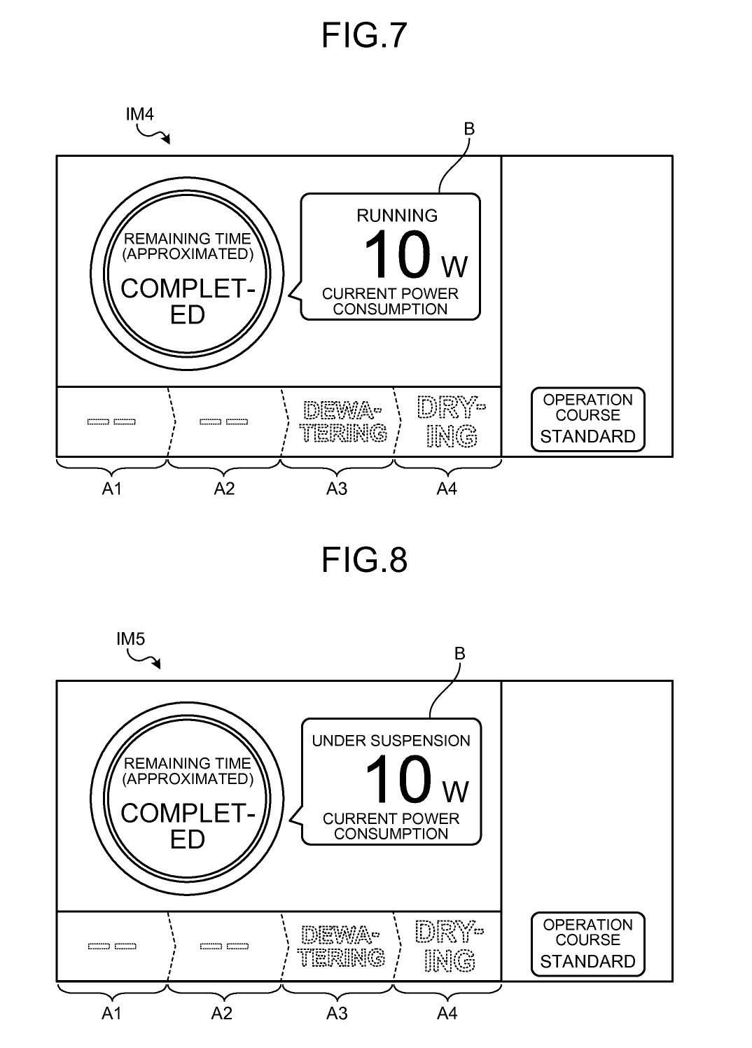

In the embodiment, the washer dryer 20 is configured to perform, after drying is completed, a keeping operation (what is called softness keeping operation) for keeping dried laundries soft. Furthermore, as illustrated in FIG. 7 and FIG. 8, the display controller 33 is configured to display, when the washer dryer 20 performs the softness keeping operation, the fact that the softness keeping operation is currently performed and the fact that the softness keeping operation is completed in the screens IM4 and IM5, respectively.

For example, in the screen IM4 illustrated in FIG. 7, a display of a remaining time is the display of “COMPLETED” and all the characters in the display areas A1 to A4 are grayed out whereas a display in the balloon B is the display of “RUNNING.” Accordingly, the screen IM4 illustrated in FIG. 7 indicates that the all processes included in the operation course are completed whereas the operation of the washer dryer 20 per se has not been stopped. That is, the screen IM4 illustrated in FIG. 7 indicates a fact that the softness keeping operation is currently performed.

Furthermore, in the screen IM5 illustrated in FIG. 8, in the same manner as the above-mentioned case in FIG. 7, a display of a remaining time is the display of “COMPLETED”, and all the characters in the display areas A1 to A4 are grayed out. However, in the screen IM5 illustrated in FIG. 8, in contrast with the above-mentioned case in FIG. 7, a display in the balloon B is the display of “UNDER SUSPENSION.” Accordingly, the screen IM5 illustrated in FIG. 8 indicates that all processes included in the operation course are completed and thereafter, the operation of the washer dryer 20 per se has been stopped. That is, the screen IM5 illustrated in FIG. 8 indicates a fact that the softness keeping operation is completed.

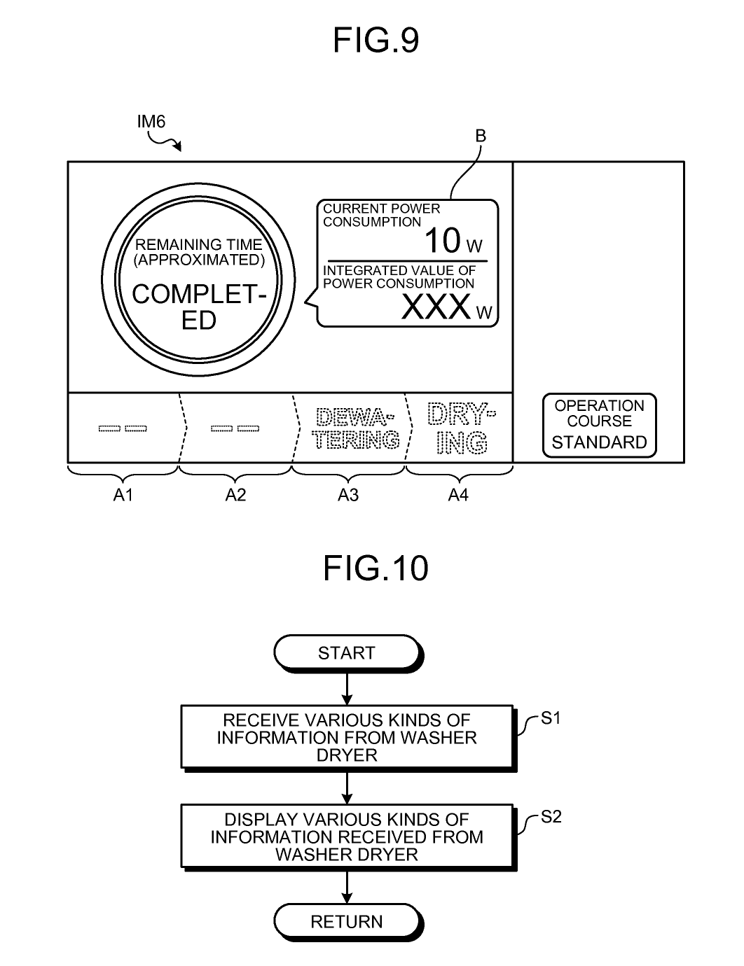

Here, in the embodiment, the communication controller 32 is configured to acquire an instantaneous value of power consumption at present time and an integrated value of the power consumption from the start of the operation of washer dryer 20 to the present time as information that indicates the power consumption of the washer dryer 20. Furthermore, as illustrated in FIG. 9, the display controller 33 is configured to be capable of displaying simultaneously the instantaneous value of the power consumption at present time and the integrated value of the power consumption from the start of the operation of washer dryer 20 to the present time in the screen IM6 (balloon B).

FIG. 9 illustrated an example in which the instantaneous value and the integrated value of power consumption are simultaneously displayed in the balloon B. However, the embodiment is not limited to this example. In the embodiment, only the integrated value of the power consumption may be displayed in the balloon B. That is, in the embodiment, in the balloon B of each of the screens IM1 to IM5 illustrated in FIG. 4 to FIG. 8, respectively, not the instantaneous value but the integrated value may be displayed as the value of the power consumption. Furthermore, in the embodiment, the display of power consumption in the balloon B may be switched between the instantaneous value and the integrated value based on the operation of the operation module 13 by a user.

In addition, in the embodiment, various kinds of information received from the washer dryer 20 may include failure information that indicates the occurrence of failures (abnormalities) such as the clogging of a drain outlet. In this case, the display controller 33 may display the occurrence of failures on each of the screens IM1 to IM6 based on the failure information received by the communication controller 32.

Next, with reference to FIG. 10, one example of the processing performed when the information display program 30 is executed by the controller 14 in the embodiment is explained.

In the embodiment, as illustrated in FIG. 10, first of all, the communication controller 32 receives various kinds of information from the washer dryer 20 at S1. Here, the various kinds of information received are as follows; that is, information that indicates an operation course set to the washer dryer 20, information that indicates a process currently performed by the washer dryer 20, information with respect to the instantaneous value and integrated value of power consumption of the washer dryer 20, information that indicates a remaining time until the operation course is completed, information that indicates whether the washer dryer 20 is in operation or under suspension, or the like. When the communication controller 32 receives the various kinds of information from the washer dryer 20, the processing advances to S2.

Next, at S2, the display controller 33 displays the various kinds of information received at S1 on each of the screen IM1 to IM6, and the processing returns. That is, the communication controller 32 periodically receives the above-mentioned various kinds of information at certain time intervals, and the display controller 33 changes over, when the information acquired by the communication controller 32 is updated, the displays on the screens IM1 to IM6 depending on the contents of the updated information.

As explained heretofore, in the embodiment, the communication controller 32 is configured to receive information that indicates an operation course set to the washer dryer 20, and information that indicates a process performed currently by the washer dryer 20 from the washer dryer 20. Furthermore, the display controller 33 is configured to display the screens IM1 to IM6 (see FIG. 4 to FIG. 9) each of which comprises the four display areas A1 to A4 corresponding to four processes (washing, rinsing, dewatering, and drying) performed by the washer dryer 20 on the display 12. Each of the screens IM1 to IM6 is configured to display each of one or more processes included in an operation course in the corresponding area out of the four display areas A1 to A4 in such a manner that a process currently performed by the washer dryer 20, a process to be performed hereafter by the washer dryer 20, and a process previously performed by the washer dryer 20 can be discriminated from each other. Accordingly, the process performed previously by the washer dryer 20 is capable of being discriminated from the process that is not originally included in the operation course and, at the same time, the progress of each process included in the operation course can be confirmed just by looking at the display 12.

In addition, in the embodiment, as described above, the display controller 33 is configured to display each of the screens IM1 to IM6 (see FIG. 4 to FIG. 9) on the display 12 when an operation course is set to the washer dryer 20 and an operation start instruction is made with respect to the washer dryer 20. This can prevent display of each of the screens IM1 to IM6 in a state that neither the setting of the operation course nor the operation start instruction has been made. Here, in the embodiment, a user who performs the setting of the operation course and the operation start instruction may differ from a user of the display terminal 10. In this case, in the embodiment, as described above, the user of the display terminal 10 can discriminate the process previously performed by the washer dryer 20 from the process that is not originally included in the operation course just by looking at the display 12. Hence, for example, even when the operation of the washer dryer 20 appears to start dewatering directly without performing washing and rinsing, it is identifiable that the washing and the rinsing are not originally included in the operation course just by looking at the display 12. That is, the user of the display terminal 10 can identify easily that the situation of starting dewatering directly without performing washing and rinsing does not arise from the abnormality of the washer dryer 20 but meets the intention of the other user who performs the setting of the operation course.

Furthermore, in the embodiment, as described above, the display controller 33 is configured to display a process that is not included in an operation course on each of the display areas A1 to A4 in a manner capable of identifying that the process is not included in the operation course. Accordingly, the process that is not included in the operation course can be easily identified just by looking at the display 12.

In the embodiment, as described above, the display controller 33 is configured to display fixedly the four display areas A1 to A4 in each of the screens IM1 to IM6 (see FIG. 4 to FIG. 9) in a state that four processes are arranged on the four display areas in the order in which the four processes are performed. Accordingly, each of the processes included in an operation course sequentially can be confirmed in an intuitive manner.

Furthermore, in the embodiment, as described above, the communication controller 32 is configured to be capable of receiving information that indicates the power consumption consumed by the washer dryer 20 from the washer dryer 20. The display controller 33 is configured to be capable of displaying the instantaneous value of power consumption at present time and the integrated value of power consumption from the start of the operation of the washer dryer 20 to the present time in the screen IM6 (see FIG. 9). Accordingly, the progress situation of each process included in an operation course and the power consumption of the washer dryer 20 can be confirmed simultaneously.

In addition, in the embodiment, as described above, the display controller 33 is configured to display, when the washer dryer 20 performs the softness keeping operation, a fact that the softness keeping operation is currently performed and a fact that the softness keeping operation is completed in the screens IM4 and IM5 (see FIG. 7 and FIG. 8), respectively. Accordingly, the fact that the softness keeping operation is currently performed, and the fact that the softness keeping operation is completed can be confirmed easily.

As described above, the information display program 30 according to the embodiment is stored in a ROM or the like of the storage module 15. The information display program 30 is provided in the form of an installable or executable file. That is, the information display program 30 is provided in a state that the computer program is included in a computer program product having a non-transitory computer readable medium such as a CD-ROM, a flexible disk (FD), a CD-R, or a digital versatile disc (DVD).

Here, the information display program 30 maybe stored in a computer connected to a network such as the Internet, and provided or distributed via the network. Furthermore, the information display program 30 may be provided in a state that the computer program is incorporated in a ROM or the like in advance.

In addition, the information display program 30 is constituted of modules comprising the above-mentioned modules (the input controller 31, the communication controller 32, and the display controller 33). As actual hardware, the CPU of the controller 14 reads out the information display program 30 from the ROM of the storage module 15 to execute the information display program 30, and thus the above-mentioned modules are loaded on the RAM of the storage module 15, and the above-mentioned modules are generated on the RAM of the storage module 15.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a receiver configured to receive information configured to indicate an operation course and information configured to indicate a process currently performed by a washer dryer from the washer dryer, the washer dryer being configured to operate in accordance with the operation course comprising one or more processes out of at least four processes comprising washing, rinsing, dewatering, and drying; and
a display controller configured to display a screen comprising at least four display areas corresponding to the at least four processes on a display, the screen being configured to display one or more processes comprised in the operation course in the display areas in such a manner that the process currently performed by the washer dryer, a process to be performed hereafter by the washer dryer, and a process previously performed by the washer dryer are discriminable from each other.

2. The electronic device of claim 1, wherein the display controller is configured to display the screen on the display when the operation course is set to the washer dryer and an operation start instruction is made with respect to the washer dryer.

3. The electronic device of claim 1, wherein the display controller is configured to hide the process that is not comprised in the operation course on the display area or to display the process that is not comprised in the operation course on the display area in a manner capable of identifying that the process is not comprised in the operation course.

4. The electronic device of claim 1, wherein the display controller is configured to fixedly display the at least four display areas in the screen in a state that the at least four processes are arranged on the at least four display areas in the order that the four processes are performed.

5. The electronic device of claim 1, wherein
the receiver is configured to be capable of receiving information configured to indicate power consumption consumed by the washer dryer from the washer dryer, and
the display controller is configured to be capable of displaying an instantaneous value of the power consumption at present time and an integrated value of the power consumption from the start of the operation of washer dryer to the present time in the screen.

6. The electronic device of claim 1, wherein the display controller is configured to display, when a keeping operation for keeping dried laundries soft after the washer dryer completes the drying, a fact that the keeping operation is currently performed or the keeping operation is completed in the screen.

7. A computer program product having a non-transitory computer readable medium including programmed instructions, wherein the instructions, when executed by a computer, cause the computer to perform:
receiving information configured to indicate an operation course and information configured to indicate a process currently performed by a washer dryer from the washer dryer, the washer dryer being configured to operate in accordance with the operation course comprising one or more processes out of at least four processes comprising washing, rinsing, dewatering, and drying; and
displaying a screen comprising at least four display areas corresponding to the at least four processes on a display, the screen being configured to display one or more processes comprised in the operation course in the display areas in such a manner that the process currently performed by the washer dryer, a process to be performed hereafter by the washer dryer, and a process previously performed by the washer dryer are discriminable from each other.

8. A method for controlling display comprising:
receiving information configured to indicate an operation course and information configured to indicate a process currently performed by a washer dryer from the washer dryer, the washer dryer being configured to operate in accordance with the operation course comprising one or more processes out of at least four processes comprising washing, rinsing, dewatering, and drying; and
displaying a screen comprising at least four display areas corresponding to the at least four processes on a display, the screen being configured to display one or more processes comprised in the operation course in the display areas in such a manner that the process currently performed by the washer dryer, a process to be performed hereafter by the washer dryer, and a process previously performed by the washer dryer are discriminable from each other.
